(19) United States
(12) Patent Application Publication
(10) Pub. No.: US 2012/0040129 A1
(43) Pub. Date: Feb. 16, 2012

(54) SET OF NANO/MICRO STRUCTURED OBJECTS CAPABLE OF INTERLOCKING WITH EACH OTHER AND STRUCTURED OBJECT THEREOF

(75) Inventors: FAN GANG TSENG, HSINCHU CITY (TW); HSIEN CHIH PENG, HSINCHU CITY (TW)

(73) Assignee: NATIONAL TSING HUA UNIVERSITY, HSINCHU (TW)

(21) Appl. No.: 13/181,809

(22) Filed: Jul. 13, 2011

(30) Foreign Application Priority Data
Aug. 13, 2010 (TW) 099127039

(51) Int. Cl. B32B 3/06

(52) U.S. Cl. 428/99

(57) ABSTRACT

A set of nano/micro structured objects capable of interlocking with each other comprises a first part and a second part. A plurality of protrusions arranged in a matrix are disposed on a surface of a base plate of the first part. A plurality of microcavities arranged in a matrix are formed on a corresponding surface of the second part. The cross-sectional areas of a portion of each of the protrusions and microcavities decrease toward the base plate. A plurality of nano-scaled needle-shaped objects are formed on an outer sidewall of each of the protrusions or on an inner sidewall of each of the microcavities. When the two parts are combined, each of the protrusions is inserted into one of the microcavities, and the needle object of the protrusion bunts an inner sidewall of the microcavity, or the needle object of the microcavities bunts an outer sidewall of the protrusion.

### BACKGROUND OF THE INVENTION

1. Field of the Invention

The present invention relates to a set of nano/micro structured objects capable of interlocking with each other and a structured object thereof, and more particularly to a set of nano/micro structured objects for enhancing binding strength of interfaces between combined parts and a structured object thereof.

2. Description of the Related Art

A micro interlock structure is a widely used technique in micro device packaging technology, through which binding strength of an interface between two objects can be effectively improved. The function of the technique is to improve the binding strength of the interface through mechanical means, without use of chemical reaction. That is, no external chemical substance is required to add to or coat on the structure to implement the binding of two surfaces. Therefore, this technique can be widely used in packaging processes of various devices, and through the application of the micro interlock structure, no damage to the packaged devices is caused by additional chemical substances or adhesives.

The packaging processes of microfluidic devices, cellular organism detecting chips, micro fuel cells, micro optical devices and micromechanical devices have special requirements such as seal precision, biological reaction uniqueness, electrochemical characteristics, or optical characteristics. Accordingly, conventional and common adhesives, resin, or other chemical adhesives cannot be coated on the devices, and therefore, the micro interlock structure provides a solution that meets the related requirements on the devices.

At present, the implementation of the micro interlock structure has been proposed in several research papers, including “Integral Micro-Mechanical Interlock (IMMI) Joints for Polymer-Matrix Composite Structures” (Journal of Thermoplastic Composite Materials. 11 200-215) published by Robert W. Messler, Jr. and Suat Genc in 1998. This paper proposed multiple fastening models of the micro interlock structure and classified the models applicable to binding different materials.

In addition, in a journal article published by M. P. Larsson, R. R. A. Syms and A. G. Wojcik in 2005, entitled “Improved adhesion in hybrid Si-polymer MEMS via micromechanical interlocking” (J. Micromech. Microeng. 15 2074-2082), and in another journal article published by Chia-Min Lin, Wen-Chih Chen and Weileun Fang in 2007, entitled “Removable fast package technology for MEMS devices using polymer connectors and silicon sockets” (J. Micromech. Microeng. 17 2461-2468), both utilized micro machining technique to form an inter-fastening microstructure on respective binding surfaces of two objects. Moreover, in a paper entitled “Black silicon—new functionalities in Microsystems” (J. Micromech. Microeng. 16 S82-S87) published by M. Stubenrauch, M. Fischer, C. Kremin, S. Stoebenau, A. Albrecht and O. Nagel, dense nano-scaled needle-shaped objects are formed on respective surfaces of two silicon substrates, the needle-shaped objects on one silicon substrate pierce into gaps between the needle-shaped objects on the other silicon substrates to produce desirable friction, so that the two silicon substrates bond firmly with each other. In the foregoing articles, the objects are bonded with each other through (a) structures of complementary shapes, which fail to provide sufficient binding force; or (b) mutual insertion of the silicon needle-shaped objects. Although a certain degree of binding force is obtained to resist an external tensile stress, a shear stress may easily cause the brittle silicon needle-shaped objects to break.

In summary, a set of nano/micro structured objects for enhancing the binding strength of the interfaces between the combined parts and a structured object thereof are required, so that the interface can provide a sufficient binding force to resist the external tensile stress, and the damage due to the external shear stress parallel to the interface is prevented.

### SUMMARY OF THE INVENTION

The objective of the present invention is to provide a set of nano/micro structured objects capable of interlocking with each other and a structured object thereof, so as to enhance binding strength of interfaces between combined objects.

To sum up, the present invention provides a set of nano/micro structured objects capable of interlocking with each other, wherein the set comprises a first part and a second part. A plurality of protrusions arranged in a matrix are disposed on a surface of a base plate of the first part, wherein the surface of the base plate is configured to contact a surface of the second part. A plurality of microcavities arranged in a matrix are formed on a corresponding surface of the second part. The cross-sectional areas of a portion of each of the protrusions and microcavities decrease toward the base plate. A plurality of nano-scaled needle-shaped objects are formed on an outer sidewall of each of the protrusions or on an inner sidewall of each of the microcavities. When the first part is combined with the second part, each of the protrusions is inserted into one of the microcavities, and the needle object of the protrusion bunts an inner sidewall of the microcavity, or the needle object of the microcavities bunts an outer sidewall of the protrusion.

The present invention further provides nano/micro structured objects capable of interlocking with each other, which include a base plate and a plurality of protrusions or cavities. The plurality of protrusions are arranged in a matrix on a surface of the base plate. The cross-sectional areas of a portion of each of the protrusions and cavities decrease toward the base plate, and a plurality of nano-scaled needle-shaped objects are formed on a sidewall of each of the protrusions or cavities.

The technical features and advantages of the present invention are described above, so that the detailed description of the present invention below can be easily understood. Other technical features and advantages of the patent application of the present invention are described below. Persons of ordinary skill in the art should understand that the concept and specific embodiments of the present invention can be easily modified or designed as a basis for other structures or processes to implement the same objective as that of the present invention. Persons of ordinary skill in the art also should understand that the equivalent architecture still falls with the concept and scope of the present invention as defined in the appended claims.

### BRIEF DESCRIPTION OF THE DRAWINGS

The invention will be described according to the appended drawings in which:

FIG. 1 is a schematic three-dimensional view of a first part according to an embodiment of the present invention;

FIG. 2 is a schematic three-dimensional view of a second part according to an embodiment of the present invention;

FIG. 3 is a schematic sectional view of a set of nano/micro structured objects capable of interlocking with each other according to an embodiment of the present invention;

FIG. 4 is an amplified view of Part A in FIG. 3;

FIGS. 5A to 5C illustrate pictures of the first part and protrusions thereof according to an embodiment of the present invention;

FIG. 6 is a stretching test data diagram of a set of nano/micro structured objects capable of interlocking with each other according to an embodiment of the present invention; and

FIGS. 7A to 7D are schematic sectional views of a protrusion and a cavity according to an embodiment of the present invention.

### DETAILED DESCRIPTION OF THE INVENTION

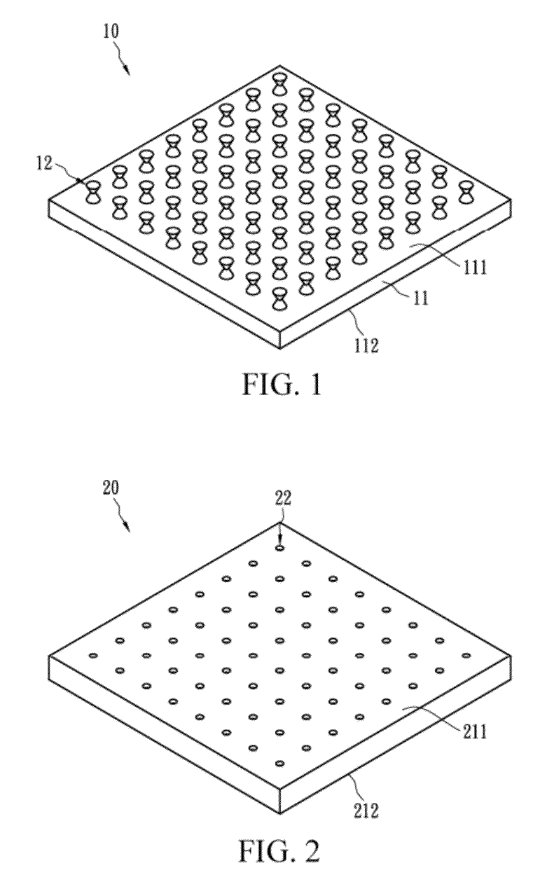

FIG. 1 is a schematic three-dimensional view of a first part according to an embodiment of the present invention. The first part 10 includes a base plate 11 and a plurality of protrusions 12 arranged in a matrix. The base plate 11 includes a first surface 111 and a second surface 112, and the plurality of protrusions 12 are disposed on the first surface 111. The materials of the base plate 11 and the protrusion 12 may be silicon wafers or glass. The plurality of protrusions 12 in an hourglass shape are formed on a surface of the wafer through MEMS technology. However, the shape of the protrusion 12 is not limited to this embodiment, and as long as the cross-sectional area of an upper portion of the protrusion decreases toward the base plate, any shape may fall within the scope of the present invention.

FIG. 2 is a schematic three-dimensional view of a second part according to an embodiment of the present invention. The second part 20 includes a first plane 211 and a second plane 212, and a plurality of microcavities 22 arranged in a matrix are disposed on the first plane 211. The shape of the microcavities 22 is designed to accommodate each protrusion 12, and the depth of the microcavities 22 may be smaller than the height of the protrusion 12. The material of the second part 20 is an elastic polymer, such as poly-perfluorosulfonic acid (PFSA), poly-dimethylsiloxane (PDMS), SU-8 photoresist, epoxy, resin, and the combination thereof, therefore, the second part may be elastically deformed to accommodate the protrusion 12 in the hourglass shape. However, the materials of the first part 10 and the second part 20 are not limited to this embodiment, and the materials in the foregoing examples may be interchanged, that is, the material of the first part 10 may be the elastic polymer, and the material of the second part 20 may be the silicon wafers or glass.

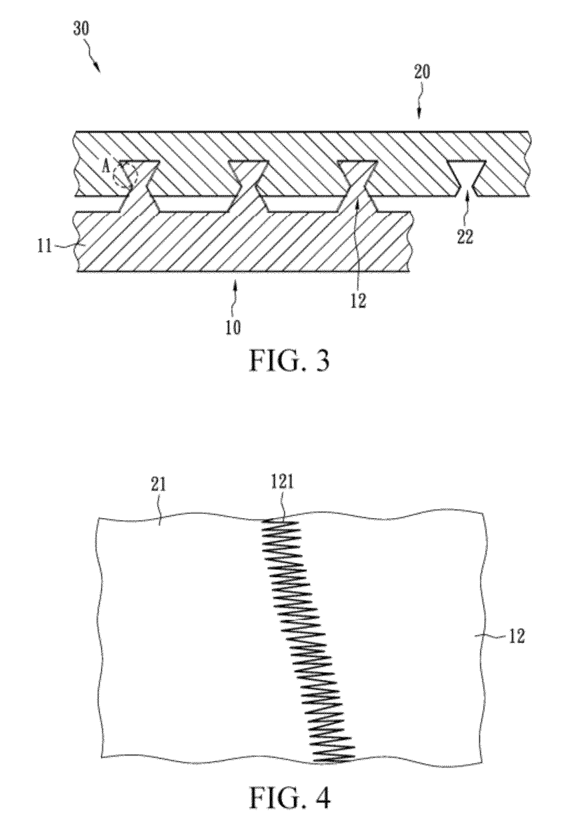

FIG. 3 is a schematic cross-sectional view of a set of nano/micro structured objects capable of interlocking with each other according to an embodiment of the present invention. The set of nano/micro structured objects 30 includes the first part 10 and the second part 20 as described above, and each of the protrusions 12 may be inserted into one of the microcavities 22, so that a desirable binding force is produced therebetween to resist an external tensile stress for separating the two. When the second part 20 is a proton exchange membrane of a micro fuel cell, if the material of poly (perfluorosulfonic acid) is used, the second part 20 cannot be closely combined with the silicon first part and may easily fall off. Other chemical adhesives that block the proton exchange cannot be used to combine the two. Therefore, the present invention is capable of solving the problem.

FIG. 4 is an enlarged view of Part A in FIG. 3. A plurality of nano-scaled needle-shaped objects 121 are formed on a sidewall of the protrusion 12, and may thus pierce into and bunt an inner sidewall of the cavity 21. The needle-shaped objects 121 are nanowires, and a desirable and sufficient friction is produced between the needle object 121 and the inner sidewall of the microcavity 21.

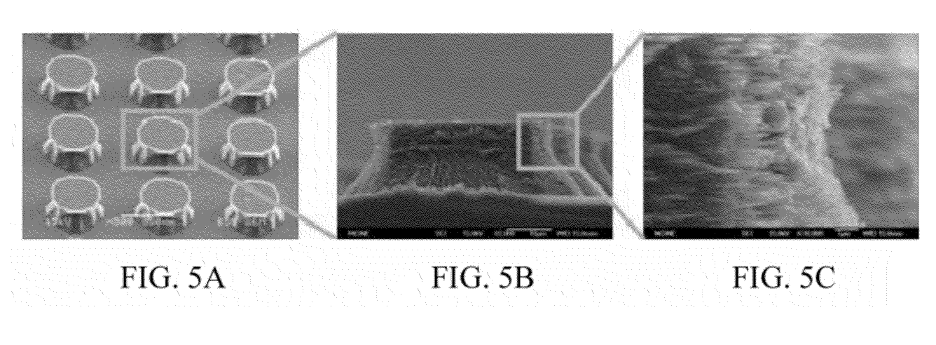

FIGS. 5A to 5C are pictures of the first part and the protrusions thereof according to an embodiment of the present invention. FIG. 5A illustrates a plurality of protrusions disposed on an outer sidewall of the first part. FIG. 5B is an electron micrograph of a section of one protrusion, in which the cross-sectional area of an upper portion or an upper third portion of the protrusion decreases toward the base plate below. It is clear that a plurality of nano-scaled needle-shaped objects or nanowires are formed on a sidewall by enlarging the upper portion of the protrusion in FIG. 5C.

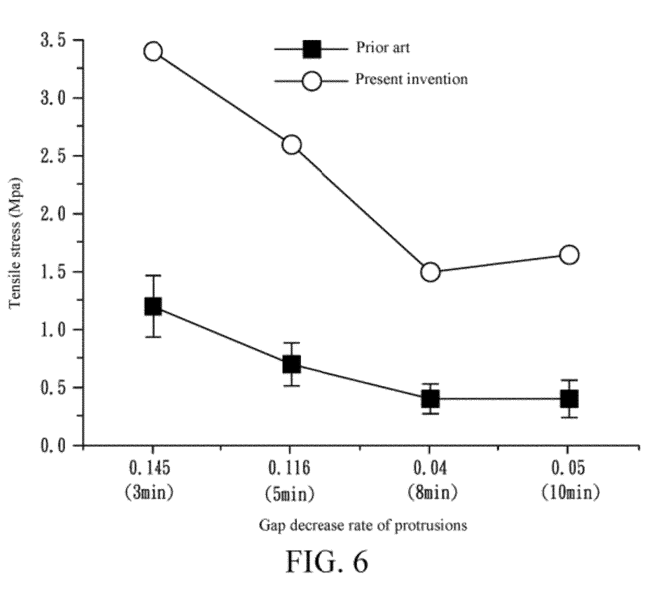

FIG. 6 is a tensile test data diagram of a set of nano/micro structured objects capable of interlocking with each other according to an embodiment of the present invention. Compared to the prior art, the binding strength of the combined interface can be dramatically improved through the means of the present invention. Moreover, the tensile stress may be increased by 100% or more.

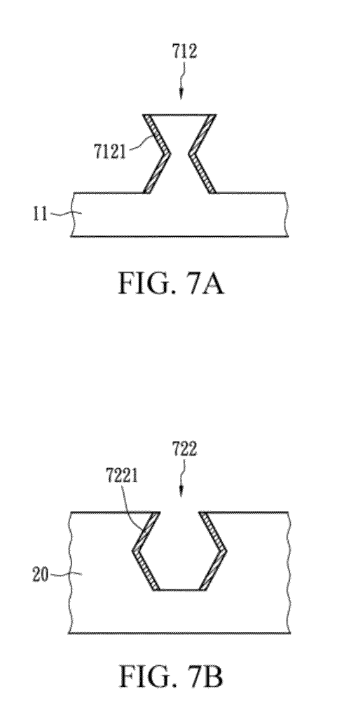

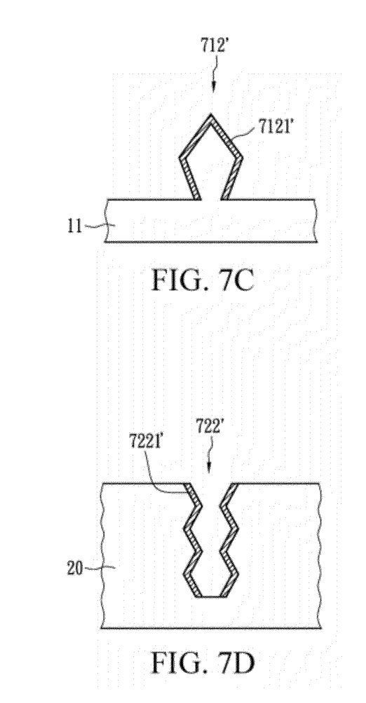

FIGS. 7A to 7D are schematic cross-sectional views of a protrusion and a cavity according to an embodiment of the present invention. In FIGS. 7A and 7C, the cross-sectional areas of a portion of protrusions (712, 712′) decreases toward the base plate 11, and nano-scaled needle-shaped objects (7121, 7121′) cover the two outer sidewalls of the protrusions. In FIGS. 7B and 7D, the cross-sectional areas of a portion of microcavities (722, 722′) decrease toward the base plate 11 to be bonded with, and the nano-scaled needle-shaped objects (7221, 7221′) cover the two inner sidewalls of the microcavities.

The technical content of the present invention is disclosed above, but persons skilled in the art may still make various modifications and displacements without departing from the spirit of the present invention based on the teaching and disclosure of the invention. Therefore, the protection scope of the present invention is not limited to the embodiments of the present invention, and shall include the modifications and displacements without departing from the spirit of the present invention as defined by the appended claims.

What is claimed is:

1. A set of nano/micro structured objects capable of interlocking with each other, comprising:
a first part, comprising a base plate and a plurality of protrusions arranged in a matrix on a surface of the base plate, wherein a cross-sectional area of a portion of each of the protrusions decreases toward the base plate; and
a second part, wherein a plurality of microcavities arranged in a matrix are disposed on a surface of the second part;
wherein each of the protrusions is inserted into one of the microcavities, a plurality of nano-scaled needle-shaped objects are disposed on an outer sidewall of each protrusion, or on an inner sidewall of each microcavity, and the needle-shaped objects bunt an inner sidewall of the cavity or an outer sidewall of the protrusion.

2. The set of nano/micro structured objects capable of interlocking with each other according to claim 1, wherein the needle-shaped objects are nanowires.

3. The set of nano/micro structured objects capable of interlocking with each other according to claim 1, wherein the protrusion is in an hourglass shape.

4. The set of nano/micro structured objects capable of interlocking with each other according to claim 1, wherein the material of the first part is silicon wafers or glass, and the material of the second part is elastic polymer.

5. The set of nano/micro structured objects capable of interlocking with each other according to claim 1, wherein the material of the second part is silicon wafers or glass, and the material of the first part is elastic polymer.

6. The set of nano/micro structured objects capable of interlocking with each other according to claim 4, wherein the elastic polymer is selected from the group consisting of poly-perfluorosulfonic acid (PFSA), poly-dimethylsiloxane (PDMS), SU-8 photoresist, epoxy, resin, and the combination thereof.

7. The set of nano/micro structured objects capable of interlocking with each other according to claim 5, wherein the elastic polymer is selected from the group consisting of poly-perfluorosulfonic acid (PFSA), poly-dimethylsiloxane (PDMS), SU-8 photoresist, epoxy, resin, and the combination thereof.

8. A set of nano/micro structured objects capable of interlocking with each other, comprising:
a base plate; and
a plurality of protrusions, arranged in a matrix on a surface of the base plate, wherein a cross-sectional area of an upper portion of each protrusion decreases toward the base plate, and a plurality of nano-scaled needle-shaped objects are disposed on an outer sidewall of each protrusion.

9. The nano/micro structured objects capable of interlocking with each other according to claim 8, wherein the needle-shaped objects are nanowires.

10. The nano/micro structured objects capable of interlocking with each other according to claim 8, wherein the protrusion is in an hourglass shape.

11. The nano/micro structured objects capable of interlocking with each other according to claim 8, wherein the materials of the base plate and the plurality of protrusions are silicon wafers or glass.

12. The nano/micro structured objects capable of interlocking with each other according to claim 11, wherein the plurality of protrusions are formed on a surface of the silicon wafer through Micro Electro Mechanical Systems (MEMS) technology.
